(19) United States
(12) Patent Application Publication
(10) Pub. No.: US 2026/0225356 A1
(43) Pub. Date: Aug. 6, 2026

(54) STRETCHED FILM, LAMINATE WITH SUCH A FILM, USE OF THE FILM, AS WELL AS PACKAGING WITH OR MADE OF SUCH A FILM

(71) Applicant: HUHTAMAKI FLEXIBLE PACKAGING GERMANY GMBH & CO. KG, Ronsberg (DE)

(72) Inventors: Eddy DAELMANS, Dilsen-Stokkem (BE); Marco HILTY, Zürich (CH); Wojciech SKALBANI, Izabelin (PL); Ashwini Kumar SINGH, Navi Mumbai District-Raigad, Maharashtra (IN)

(21) Appl. No.: 19/132,295

(22) PCT Filed: Nov. 29, 2023
(86) PCT No.: PCT/EP2023/083540

§ 371 Date: May 22, 2025

(30) Foreign Application Priority Data
Dec. 1, 2022 (DE) 10 2022 131 874.5

(51) Int. Cl. B32B 27/08; B32B 27/30; B32B 27/32; B32B 27/34

(52) U.S. Cl. CPC B32B 27/08; B32B 27/306; B32B 27/32; B32B 27/34; B32B 2250/02; B32B 2250/24; B32B 2307/31; B32B 2307/516; B32B 2307/72; B32B 2307/7242; B32B 2439/40

(57) ABSTRACT

The invention relates to a stretched film (10), in particular for use in the production of packaging, wherein the stretched film (10) is stretched uniaxially in the machine direction with a stretch ratio of 1.2 to 1.75, preferably with a stretch ratio of 1.3 to 1.5, as well as a laminate with such a film (10), a use of such a film (10) and a packaging produced with such a film (10).

The invention relates to a stretched film according to the preamble of claim 1, a laminate with such a film according to the preamble of claim 6, a use of such a film according to the preamble of claim 8 and packaging with such a film according to the preamble of claim 11.

Stretched films for the production of packaging have been known for some time. According to the prior art, the stretched films were used, for example, to provide a laminate with directional tear properties which are helpful when opening the packaging, usually a tubular bag packaging. By stretching the film, the molecular chains within the film were stretched in the direction of stretching, so that the molecular chains came to lie more or less parallel to each other and, when the packaging was torn open, caused the tear to extend through the film essentially along the molecular chains and not across the packaging film. For this purpose, very high stretching ratios in the region of at least 1:3 to 1:15 have always been used in accordance with the prior art in order to achieve as monoaxial an orientation as possible of the molecular chains defining the tear line. Such a packaging film is described, for example, in German publication DE 10 2011 001 323 A1. A further advantage of such stretched films is that, as mentioned above, in such films essentially molecular chains that are more or less parallel to each other are present, which form crystalline regions in the stretched film, which in turn have barrier properties, in particular with regard to water vapour permeability.

However, a major disadvantage associated with such films is that, due to the alignment of their molecular chains, they are practically impossible to seal, even if the base material of the film is actually a material that is easy to seal, such as polyethylene or polypropylene.

This brings with it another significant disadvantage, namely the fact that such stretched films known from the prior art could only ever form part of a packaging laminate, for example to define a specific tear direction of the film and/or to provide specific barrier properties against water vapour. It was always important to ensure that the stretched film did not impair the properties of other films in a laminate and their functionality, but was sufficiently dominant in terms of its own functionality with regard to tear direction and barrier properties so that these properties were also retained in the overall laminate. In particular, with oriented films in laminates known from the prior art or used according to the prior art, it was always necessary to integrate at least one sealing layer into the laminate in order to obtain a sealable laminate at all. However, since the stretched film, i.e. the film oriented in the machine direction, itself could not be sealed, a bond of such an additionally necessary sealing layer to the stretched film was only possible with the aid of an adhesive, which was problematic not only in terms of increased costs due to this but also in terms of reduced chemical resistance resulting form this.

The invention is based on the object of providing a stretched film with good tear and barrier properties while avoiding the above-mentioned disadvantages, as well as a laminate with such a film, a use of such a film and a packaging made from or with such a film, wherein the stretched film can be produced simply and inexpensively.

This object is solved by a stretched film according to claim 1, by a laminate with such a film according to claim 6, as well as by a use of such a film according to claim 8 and by a packaging according to claim 11, which is made from or with such a film.

In particular, the object is solved by a stretched film, in particular for use in the production of packaging, wherein the stretched film is stretched uniaxially in the machine direction with a stretch ratio of 1.2 to 1.75, preferably with a stretch ratio of 1.3 to 1.5.

An essential feature of the invention is, as was surprisingly found, that the stretched film according to the invention is stretched uniaxially in the machine direction and has only a moderate low stretch ratio in the range of 1.2 to 1.75 and preferably in the range of 1.3 to 1.5.

As has been found in accordance with the invention, although such a stretched film already has very good directional tear properties and also very good barrier properties, it nevertheless has sufficient non-highly oriented molecular chains to still exhibit very good sealing properties, unlike stretched films known from the prior art.

Thus, within the scope of the invention, on the one hand the previous prejudice known from the prior art that a stretched film is not sealable could be refuted, as well as, on the other hand, that, in order to achieve good tear properties and good barrier properties, stretching with as large a stretch ratio as possible of up to 1:15, as mentioned above, is necessary.

According to a preferred embodiment of the invention, the stretched film comprises a polyester layer or, preferably, a polyolefin layer, in particular a polyethylene layer, preferably of a high-density polyethylene such as HDPE, or is made of one of the aforementioned materials, optionally pure in type.

A use of polyethylene for producing the film stretched according to the invention is particularly advantageous, since polyethylene is a very inexpensive plastic and is a very good material sealable at relatively low temperatures in the range of 80° C. to 130° C. In addition, polyethylene is easy and uncomplicated to process. High-density polyethylene, such as HDPE, has proven to be particularly suitable for producing a film stretched according to the invention with good tear, barrier and sealing properties.

As mentioned above, the film stretched according to the invention can be either a film produced from a material pure in type, consisting exclusively of a polyester, such as polyethylene terephthalate, or, as particularly preferred according to the invention, exclusively from a polyethylene, such as HDPE, which is particularly preferred according to the invention, especially from a recycling point of view, or it may contain further, in particular functional, layers.

According to a particularly preferred embodiment, the stretched film further is preferably a multi-layer blown film. Such a blown film can be produced particularly simply, inexpensively and, in particular, also extremely variably with a wide variety of film layers and a very high surface output, which affects the manufacturing costs of the film according to the invention in an extremely advantageous manner.

According to a further embodiment of the invention, the stretched film comprises, in addition to, perhaps polyethylene terephthalate, however preferred according to the invention, polyethylene also a barrier layer material such as polyamide and/or ethylene vinyl alcohol copolymer (EVOH). In this way, in addition to high water vapour impermeability, a very high barrier effect against gases such as carbon dioxide and oxygen can be achieved in a very simple and advantageous manner, so that the film stretched according to the invention can be used very universally in many areas in which water vapour and gas impermeability is important, for example with regard to products which either themselves are gas-containing, in particular carbon dioxide-containing, or which are sensitive to oxidation. Also, an application of the film stretched according to the invention in the tropics with very high air humidity is possible in this way.

According to a further preferred embodiment of the invention, the stretched film can be formed as a composite of the following layers: polyethylene, in particular HDPE/primer/barrier layer material, namely EVOH or polyamide/primer/polyethylene, in particular HDPE. Such a stretched film can be, as has been found according to the invention, excellently employed as a high-barrier film which is impermeable to both water vapour as well as gases, in particular oxygen and carbon dioxide.

In addition, the stretched polyethylene film according to the invention has excellent stiffness, which is particularly evident in the form of a high bending stiffness with a modulus of elasticity in the range of 700 N/mm² to 1000 N/mm², preferably in the range of 745 N/mm² to 980 N/mm², and particularly preferably in the range of 760 N/mm² to 960 N/mm², due to which the stretched film according to the invention is very well suited for the production of packaging able to stand.

Furthermore, the object of the invention is also solved by a laminate comprising a stretched film according to the above description or consisting of such a stretched film, provided that the stretched film itself is multilayered.

Such a laminate exhibits very good properties with regard to its barrier properties as well as with regard to the sealability of the laminate, whereby the laminate can achieve a permeability to water vapour in an atmosphere with 85% relative humidity, for example, in the range of less than 0.5 g/m²/day up to a value of less than 0.1 g/m²/day. Similarly, a permeability of the laminate according to the invention to oxygen at a temperature of 23° C. and in an atmosphere with 85% relative humidity can be reduced to a value of less than 0.5 cm³/m²/day or even less than 0.2 cm³/m²/day. The oxygen permeability measurements were carried out in accordance with DIN standard 53380-3. The water vapour permeability measurements were carried out in accordance with DIN standard 53122-2.

An essential feature of the invention here is that the stretched film provides a sealing layer for the laminate. For this purpose, the film stretched according to the invention is provided with an external sealing medium, such as polyethylene, which has been stretched together with the film. To produce the laminate according to the invention, any further layers of the laminate are bonded to the stretched film in such a way that the sealing layer of the stretched film is arranged at the outermost part of the laminate, i.e. forms an outermost layer of the laminate.

Furthermore, the object of the invention is also solved by the use of a stretched film according to the description above, in that the stretched film is used to produce a laminate, in particular a packaging laminate, and/or to produce a package.

Due to the straight-line optimised tearing properties of the film stretched according to the invention, as well as of a laminate produced with the stretched film, such packaging can be opened particularly easily without the risk of oblique tearing or unintentional destruction of the packaging, possibly with loss of the packaging contents.

As mentioned above, the stretched film or an outermost layer of the stretched film, in the case of a use of the stretched film for the production of a laminate, constitutes a sealing layer of the laminate.

Accordingly, the stretched film or an outermost layer of the stretched film is also used according to the invention for sealing the packaging to be produced.

Furthermore, the object of the invention is also solved by a packaging, in particular a tubular bag packaging with or without a bottom, wherein the packaging is produced with or from a stretched film according to the above description. In an analogous manner, the packaging can also be produced with or from a laminate according to the above description. Such a packaging has, as mentioned above, excellent opening properties as well as very good barrier properties with regard to a permeability for water vapour and, when ethylene vinyl alcohol copolymer (EVOH) and/or polyamide is used in the film stretched and/or the laminate stretched according to the invention, also very good sealing properties with regard to oxygen and carbon dioxide.

As mentioned above, the packaging is sealed by means of the stretched film or an outermost layer of the stretched film, in particular a stretched polyethylene film or layer of film. The production of the packaging can be done in such a way that two or more blanks of the stretched film according to the invention or the laminate according to the invention are used and connected to the packaging with their sealing layers, each; alternatively, a single blank of the stretched film according to the invention or the laminate according to the invention can be folded in such a way that respective sealing layers facing each other are then joined to form the packaging.

Further embodiments of the invention arise from the dependent claims.

The invention is described below with reference to an exemplary embodiment, which is explained in more detail with reference to a figure. Here,

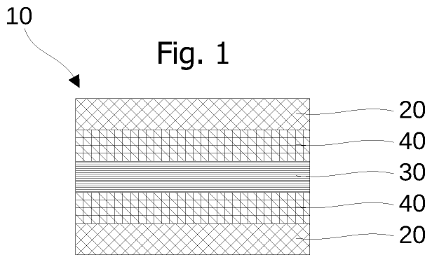

FIG. 1 shows a schematic representation of an embodiment of the stretched film according to the invention.

In the following description, the same reference numbers are used for identical and similarly functioning parts.

FIG. 1 shows a schematic representation of an embodiment according to the invention of the stretched film 10. The stretched film 10 has an inner barrier layer material 30, which may be ethylene vinyl alcohol copolymer (EVOH) or polyamide, as desired, in order to reduce the permeability to gases such as carbon dioxide or oxygen to as low a level as possible. The barrier layer 30 has a thickness in the range of 1 μm to 5 μm, but may also be in a range of 1.5 μm to 4 μm or in a range of 2 μm to 3 μm, depending on the requirements.

A primer layer 40 abuts against the barrier layer 30 on both sides, wherein the application weight of the solvent-based or preferably water-based primer is in a range of 0.2-2 g/m², preferably in a range of 0.3-1 g/m² and particularly preferably in a range of 0.4-0.6 g/m², which, according to the invention, corresponds to layer thicknesses in the range of 0.2-2 μm, preferably in the range of 0.3-1 μm and particularly preferably in the range of 0.4-0.6 μm.

As outermost layer of the film 10 stretched according to the invention, a polyolefin layer 20, namely a layer of polyethylene with a high density, specifically HDPE, is respectively arranged in FIG. 1, which respectively follows after the primer layer 40 on both sides. The thickness of the polyolefin layer 20, or the HDPE layer, may be identical or different and is in a range of from 2 μm to 40 μm, preferably 3 μm to 30 μm and particularly preferably in a range of from 4 μm to 20 μm.

The film stretched according to the invention is also excellently suited for the production of extremely robust tubular bags, in particular also with standing bottom, for packaging volumes of up to 10 kg and more, which are particularly suitable for packaging goods that must be kept dry. Such packaging has excellent water vapour and gas, in particular oxygen and carbon dioxide, barrier properties, as well as high seal strength, as drop tests of the filled packaging from heights of up to two metres have proven.

Examples of specific layer structures of laminates which can use the film stretched according to the invention may for example be the following layer sequences:

### Example 1

Transparent, film printable on the reverse side, namely oriented polyethylene terephthalate with a layer thickness of 12 μm/reverse printing layer, for example as engraving or flexographic printing layer/adhesive layer with an application weight of 3 g/m²/LLDPE film stretched in the machine direction according to the invention with a stretch ratio of 1:1.5 and with a layer thickness of 100 μm.

### Example 2

Transparent film, printable on the reverse side, namely biaxially oriented polypropylene with a layer thickness of 12 μm/reverse printing layer, for example as engraving or flexographic printing layer/adhesive layer with an application weight of 3 g/m²/LLDPE film stretched in the machine direction according to the invention with a stretch or orientation ratio of 1:1.5 and with a layer thickness of 100 μm.

### Example 3

Transparent film 20, namely polyethylene stretched in the machine direction with a stretch or orientation ratio of 1:1.5 and a layer thickness of 20 μm/reverse printing layer, for example as engraving or flexographic printing layer/adhesive layer with an application weight of 3 g/m²/LLDPE film stretched in the machine direction according to the invention with a stretch or orientation ratio of 1:1.5 and with a layer thickness of 100 μm.

### Example 4 With Combined Low-Temperature Sealability and Optimised Water Vapour and Gas, in Particular Oxygen and Carbon Dioxide, Impermeability

Transparent film, namely oriented polyethylene terephthalate with a layer thickness of 12 μm/reverse print layer, for example as engraving or flexographic print layer/inner lamination layer, namely polyethylene with an application weight of 20 g/m²/inner blown film, namely LLDPE film stretched in the machine direction according to the invention with a stretch or orientation ratio of 1:1.6 and with a layer thickness of 30 μm/outer lamination layer, namely polyethylene with an application weight of 20 g/m²/outer blown film 70, namely LLDPE film with a layer thickness of 40 μm as low-temperature sealing layer.

### Example 5 With Combined Low-Temperature Sealability and Optimised Water Vapour and Gas, in Particular Oxygen and Carbon Dioxide, Impermeability

Transparent film, namely polyethylene stretched in the machine direction with a stretch or orientation ratio of 1:5 and a layer thickness of 20 μm/reverse printing layer, for example as engraved or flexographic print layer/inner lamination layer, namely polyethylene with an application weight of 20 g/m²/inner blown film, namely LLDPE film stretched in the machine direction according to the invention with a stretch or orientation ratio of 1:1.6 and with a layer thickness of 30 μm/outer lamination layer, namely polyethylene with an application weight of 20 g/m²/outer blown film, namely LLDPE film with a layer thickness of 40 μm as low-temperature sealing layer.

In this context, the term ‘low-temperature sealing layer’ means that the sealing layer according to the invention is a very thin layer in the range of 2-40 μm, preferably in the range of 3-30 μm and particularly preferably in the range of 4-20 μm, which is either itself formed as a blown film, i.e. as a single-layer blown film or as the outermost layer of a multilayer blown film. The essential advantage of the blown film serving as low-temperature sealing layer, or the outermost layer of the blown film, is that the material thickness of this sealing layer according to the invention is very thin and heating to an initial sealing temperature when sealing jaws are applied to the outer layer occurs very quickly, i.e. quasi-spontaneously, and not, as in the prior art up to now, in which the thickness of the sealing layer was in the range of greater than 50 μm, but mostly even in the range of 100 μm to 140 μm, a large mass of sealing medium must first be heated in order to also reach an initial sealing temperature on the outermost side of the laminate opposite the visible face of the laminate.

In the context of this invention, the initial sealing temperature is understood to be the temperature at which the outer surface of the sealing layer melts so that a fusing of this outer surface of the sealing layer with a counterpart to be sealed is possible.

According to examples 4 and 5, the water vapour and gas barrier layer of the laminate is improved in an extremely advantageous manner by using the LLDPE film stretched unidirectionally in the machine direction according to the invention, which has been stretched with a stretch or orientation ratio of 1:1.6 to a layer thickness of 30 μm.

In particular, the above examples 3 and 5 represent particularly preferred embodiments according to the invention, since their recyclability is particularly advantageous due to the essentially pure-type structure of the laminates described.

At this point, it should be noted that all parts described above, considered individually and in any combination, in particular the details shown in the drawings, are claimed as essential to the invention. Modifications thereof are known to the person skilled in the art.

### List of Reference Signs

10 stretched film
20 polyolefin layer/polyethylene layer/HDPE
30 barrier layer material
40 primer layer

1. A stretched film, in particular for use in a production of packaging,
wherein the stretched film is stretched uniaxially in a machine direction with a stretch ratio of 1.2 to 1.75.

2. The stretched film according to claim 1,
wherein the stretched film is comprises-a polyolefin layer, in particular a polyethylene layer.

3. The stretched film according to claim 1,
wherein the stretched film is a blown film.

4. The stretched film according to claim 1,
wherein the stretched film comprises a barrier layer material of polyamide and/or ethylene vinyl alcohol copolymer (EVOH).

5. The stretched film according to claim 1,
wherein the stretched film is formed as a composite layers: polyethylene, in particular HDPE,/primer/and barrier layer material, of EVOH, or polyamide/primer/and polyethylene, in particular HDPE.

6. A laminate, in particular for use in a production of packaging,
wherein the laminate comprises a stretched film according to claim 1.

7. The laminate according to claim 6,
wherein the stretched film, is a stretched polyethylene film that forms a sealing layer of the laminate.

8. Use of a stretched film according to claim 1 for the production of a packaging laminate, and/or a packaging.

9. Use according to claim 8,
wherein the stretched film or an outermost layer of the stretched film is a sealing layer of the packaging laminate.

10. Use according to claim 8,
wherein the stretched film or an outermost layer of the stretched film is used for sealing the packaging.

11. A tubular bag packaging, produced with or from the stretched film with the laminate according to claim 7.

12. The tubular bag packaging according to claim 11,
wherein the tubular bag packaging is produced by sealing the stretched film or an outermost layer of the stretched film with a film of a same type or with a different sealing medium.

13. The stretched film according to claim 1, wherein the stretch ratio is between 1.3 to 1.5.

14. The stretched film according to claim 2, wherein the polyethylene layer is a high-density polyethylene.

15. The stretched film according to claim 3, wherein the blown film is a multi-layer blown film.
